(19) United States
(12) Patent Application Publication
(10) Pub. No.: US 2010/0299305 A1
(43) Pub. Date: Nov. 25, 2010

(54) PROGRAMMING ELEMENT MODIFICATION RECOMMENDATION

(75) Inventors: Srivatsan Laxman, Bangalore (IN); Prasad G. Naldurg, Bangalore (IN); Nachiappan Nagappan, Redmond, WA (US); Jacek A. Czerwonka, Sammamish, WA (US)

Correspondence Address: LEE & HAYES, PLLC, 601 W. RIVERSIDE AVENUE, SUITE 1400, SPOKANE, WA, 99201, US

(73) Assignee: Microsoft Corporation, Redmond, WA (US)

(21) Appl. No.: 12/471,006

(22) Filed: May 22, 2009

(51) Int. Cl. G06F 9/44; G06F 17/30

(52) U.S. Cl. 707/609; 717/120; 707/805

(57) ABSTRACT

Techniques described herein help determine dependencies and associations between CPEs in a computing system. These techniques track previous check-ins over a period of time in order to learn the dependencies and associations between CPEs. The previous check-ins are performed by a plurality of different computer programmers. In some embodiments, in response to receiving an indication that a CPE has either already been modified or is about to be modified by a computer programmer, the techniques provide the computer programmer with a recommendation indicating CPEs that are associated with the CPE being modified. This recommendation is based on the dependencies and associations determined from the previous check-ins performed by the plurality of different computer programmers.

### BACKGROUND

Conventional programming environments include one or more database(s) holding many computer programming elements (CPEs) that may be interconnected to provide expected resources and proper functionality to an end-user (e.g., a client using a computing system).

Currently, a plurality of computer programmers may contribute to the development of hundreds to thousands of CPEs stored on multiple computers hosting the programs made up of the elements. Not all CPEs depend upon one another, but with so many CPEs developed for particular computing systems and applications, there are numerous dependencies between multiple CPEs that make up particular programs like operating systems and browsers.

Thus, domain knowledge and management experience associated with dependent CPEs is reduced or lost when a programming task is transferred from one programmer to another. With this lack of domain knowledge and management, errors committed by computer programmers making one or more modifications or updates to the CPEs are more likely to damage the functionality of the programs.

### SUMMARY

This document describes tools for determining dependencies and associations between computer programming elements (CPEs) in a computing system. These tools track code check-ins in order to mine dependencies and associations between CPEs. Code check-ins may be mined for a period of time, and CPEs checked in together may be identified. Code check-ins performed by a plurality of different computer programmers may also be identified. In at least one embodiment, an indication that a CPE has either already been modified or is about to be modified, such as via a check-out, is received. In response to the received indication, the tools provide a recommendation indicating additional CPEs which are associated with the checked-out CPE. This recommendation is based on the mined dependencies and associations ascertained from previous code check-ins.

This Summary is provided to introduce a selection of concepts in a simplified form that are further described below in the Detailed Description. This Summary is not intended to identify key or essential features of the claimed subject matter, nor is it intended to be used as an aid in determining the scope of the claimed subject matter. The term “tools,” for instance, may refer to one or more systems, methods, computer-readable instructions, and/or techniques as permitted by the context above and throughout the document.

### BRIEF DESCRIPTION OF THE CONTENTS

The detailed description is presented with reference to accompanying figures. In the figures, the left-most digit(s) of a reference number identifies the figure in which the reference number first appears. The use of the same reference numbers in different figures indicates similar or identical items.

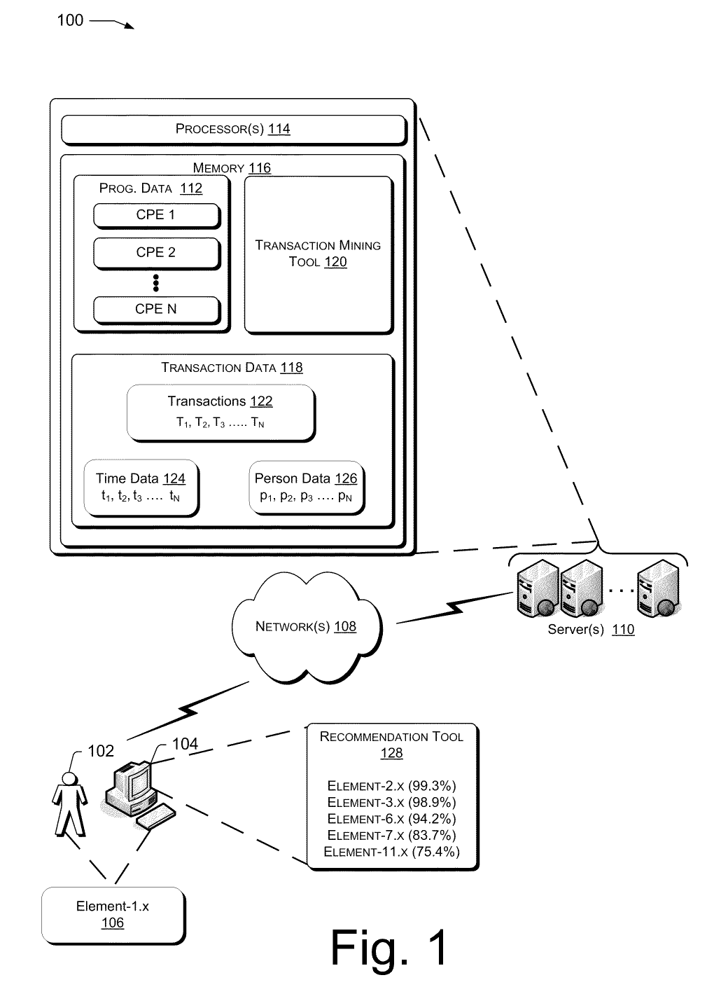

FIG. 1 illustrates an exemplary operating environment for implementing tools that recommend associated CPEs.

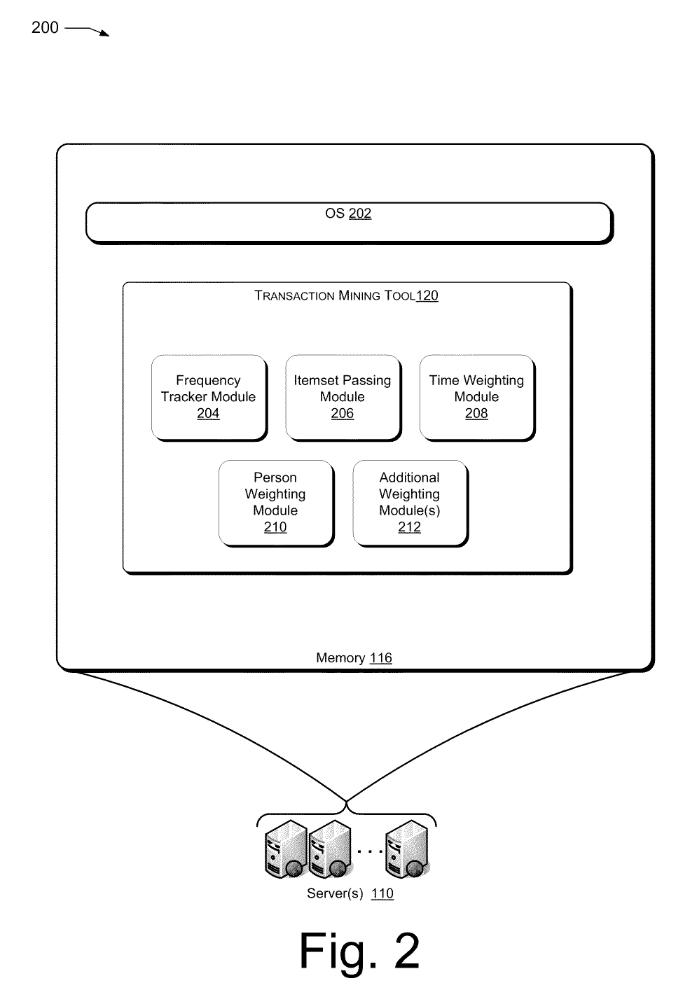

FIG. 2 further illustrates the transaction mining tool used to recommend associated CPEs.

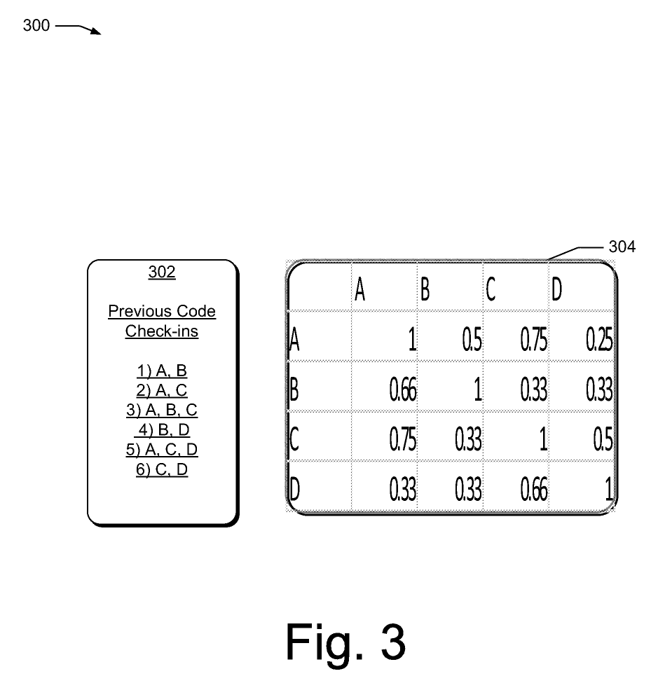

FIG. 3 illustrates one embodiment of how associations are determined.

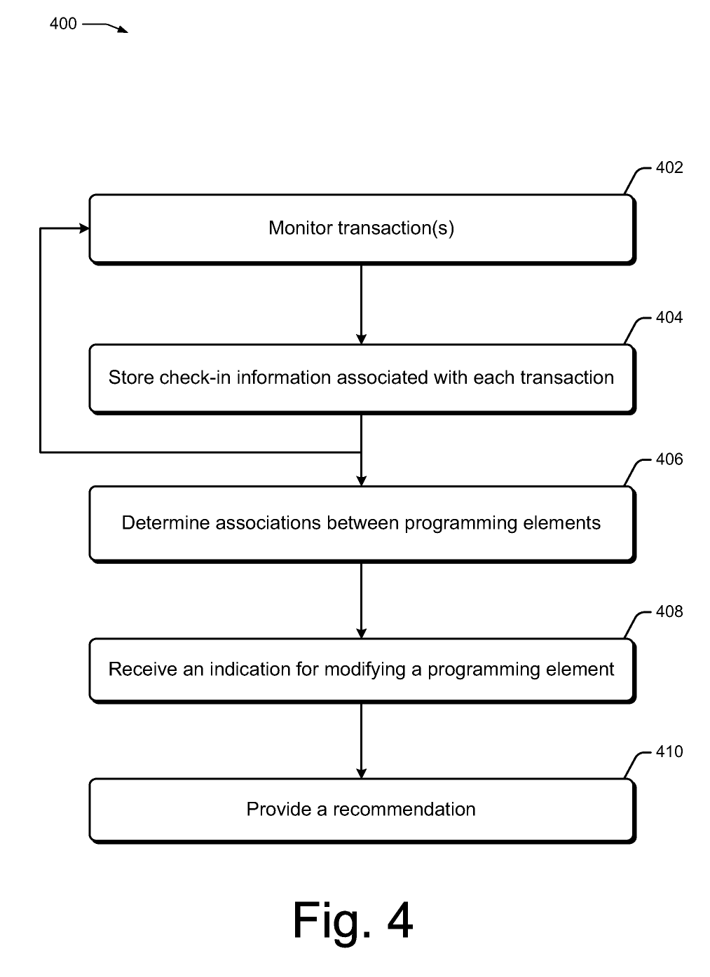

FIG. 4 illustrates an exemplary process implementing the recommendation tools in one embodiment.

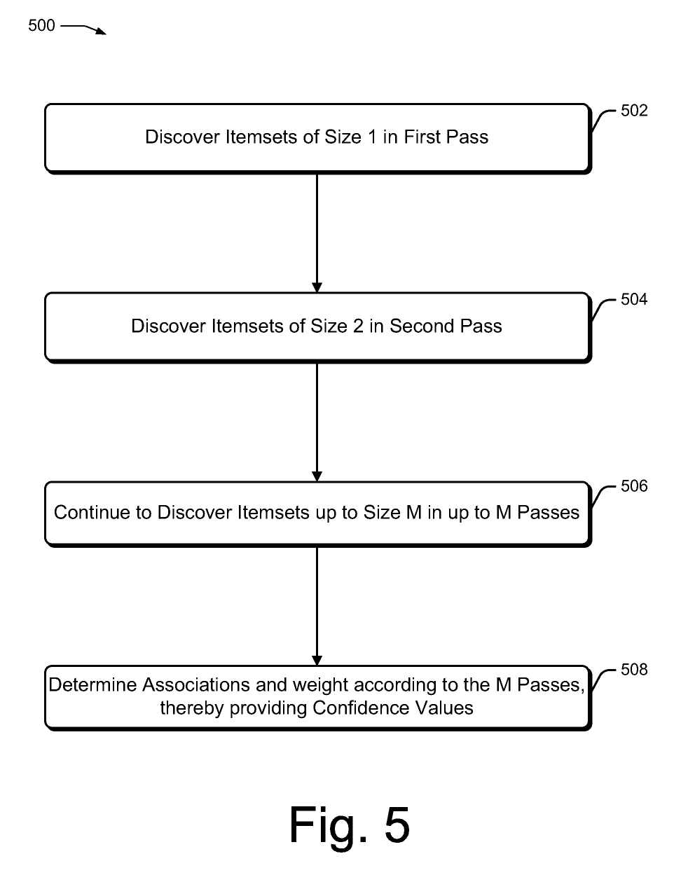

FIG. 5 illustrates another exemplary process implementing the recommendation tools in another embodiment.

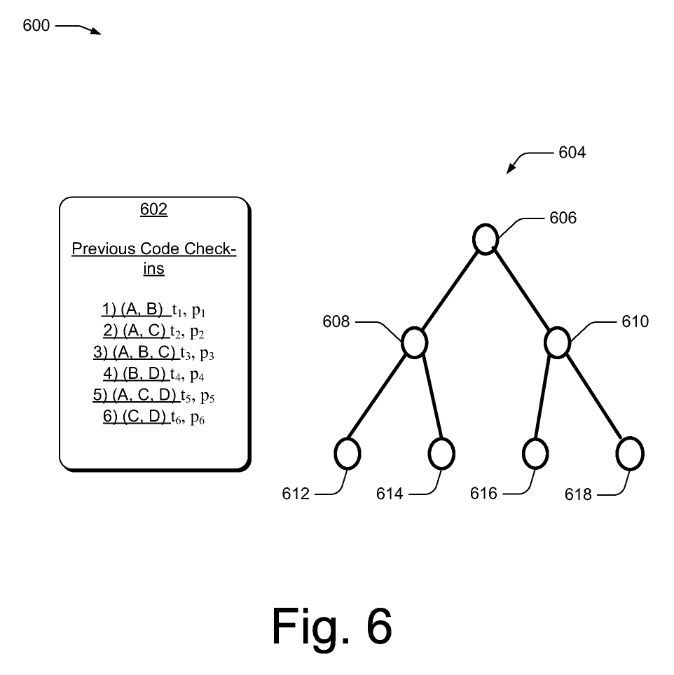

FIG. 6 illustrates additional embodiments of how associations are determined.

### DETAILED DESCRIPTION

### Overview

The following description sets forth tools for determining dependencies and associations between computer programming elements (CPEs) in a computing environment, such as during the maintenance phase of the software development life cycle (SDLC). These tools track code check-ins performed by a plurality of different programmers, extracting patterns, dependencies, and associations between CPEs. For example, associations may be based on CPEs being historically checked-in together. When performing these code check-ins the plurality of programmers develop individual skills and domain knowledge associated with the CPEs being checked-in.

In one embodiment, responsive to receiving an indication that a CPE has been checked-out and either has already been modified or is about to be modified by a computer programmer, the tools provide recommendations indicating additional CPEs associated with the CPE checked-out. For example, requesting the CPE for check-out may indicate that the CPE is about to be modified. In another example, submitting the CPE for check-in may indicate that the CPE has been modified. Because the preceding examples are not mutually exclusive, either one or both may serve as a trigger for a recommendation tool. The recommendation tool extracts patterns, dependencies, and associations ascertained from the previous code check-ins performed by the plurality of different computer programmers.

The provided recommendation can be presented to computer programmers for example, via a graphical user interface, via a command line, etc., as an indication of additional CPEs associated with a CPE being modified to facilitate transfer of domain knowledge and enhance individual skill sets. Such computer programmers include, but are not limited to, any interested programmers, inexperienced programmers, programmers newly assigned to a particular task or group, programmers modifying complex programming elements, etc.

In this way, the programmers are better able to estimate the effort and programming knowledge that may be required to make a modification to a CPE. Additionally, programmers can reduce the number of defective fixes within a programming environment and expeditiously familiarize themselves with the domain knowledge and management of a source code base.

In one practical example, as time passes, individual computer programmers cease working on a particular project at a company. For example, the programmer may retire or transfer from positions working on projects associated with a set of particular source code files that make up at least part of a particular program or project. As such, these programmers leave further development and/or maintenance tasks associated with the particular set of source code files to another programmer. Furthermore, when these programmers leave, they take with them their knowledge (built up over time) regarding this set of source code files. The recommendation tool described herein, however, helps fill this void by recommending that certain CPEs be analyzed and/or modified in response to a programmer checking-out a particular CPE.

In another practical example, source code files developed by one or more computer programmers in a source code development group for a particular area of development, are often procedurally transferred. For example, development groups transfer source code files to one or more different computer programmers in a separate source code file-maintenance group that fixes the programs when bugs are reported and adds new features and/or applications to the computing system as part of a maintenance phase.

In both of these practical examples, transferring domain knowledge and development management experience associated with the CPEs would benefit computer programmers with limited domain knowledge and development management experience of a particular application.

For example, when a programmer, checks-out a code segment from a database of CPEs in order to modify, add or delete a set of CPEs previously written or maintained by another programmer, the programmer may have limited knowledge of the inner-workings of the set of CPEs and any implicit relationships between CPEs. This scenario may occur when there is a large number of CPEs with hundreds to thousands of lines of source code interconnected and dependent upon one another, such as for operating systems, browsers, and integrated development environments. Examples include the Microsoft Windows® operating system, Internet Explorer®, and Visual Studio®. This disclosure is not limited to these implementations and other applications are also envisioned.

In order to modify one or more CPEs, a programmer checks-out (e.g. accesses) at least one CPE from a central repository in order to analyze, review and ultimately perform a modification. Checking-out CPEs may include pulling the CPEs from the central repository to a separate client computer where the programmer is working. Alternately, checking-out CPEs may include securing the checked-out CPE on the resident computer. In at least one embodiment both options are enabled. Once the modification is performed, the programmer checks-in the modified CPEs. Checking-in includes returning the modified CPEs to the central repository, thus updating the source code database.

For example, the computer programmer may check-out ten CPEs from a programming code database (e.g. the central repository), but only modify five of the ten CPEs that have been checked-out. Thus, only the five modified CPEs make up the code check-in when the programming code database is updated with the five modified CPEs. In this example, the recommendation tool may notify the programmer in an event that one or more associations or dependencies are identified between the modified and unmodified CPEs.

In another practical example, the computer programmer may modify all ten CPEs that have been checked-out. Thus, all ten modified CPEs make up the code check-in when the programming code database is updated with the ten modified CPEs. Thus, CPEs identified and associated with a particular check-in are the CPEs that have been modified by a programmer while the CPE was checked out or those checked-in within a predefined window of time, as discussed later in this document.

In yet another practical example, a programmer may not check-out any existing CPEs for modification. Instead, a programmer may develop a new set of CPEs, and then check-in the newly developed CPEs into a computing environment. In this scenario, no existing CPEs are checked-out from the computing environment. However, in this example, the newly developed CPEs can be used to mine patterns, dependencies and associations for future check-outs.

A practical example scenario when a computer programmer would benefit from transferred domain knowledge and management would be when different areas (e.g. source code files, functions, etc.) of an operating system (such as Microsoft Windows®) are developed by a plurality of computer programmers in different countries or across multiple time zones. In this exemplary scenario, it is beneficial to transfer domain knowledge and development management when building, testing and maintaining the source code files that make up the operating system.

For example, when a programmer in the United States is checking-in a set of source code files located on one or more central servers hosting the operating system, another programmer, in Taiwan, for example, may be simultaneously preparing to check-out a particular source code file in the set of source code files previously checked-in by the programmer in the United States. Thus, it would be practical and beneficial to inform the computer programmer in Taiwan of any associations and dependencies between the CPEs and/or source code files in the complete set of source code files that resulted from the check-in performed by the programmer in the United States so that errors can be avoided.

A programmer may modify, add or delete computer programming code in one or more CPEs for security purposes in response to exploitation of an application from the outside when one or more CPEs should be fixed expeditiously. Modifications may also be made for reliability purposes such as in order to be compatible with a particular piece of hardware or software running in a different part of the world for example, or for implementing new features in one or more applications. However, it is to be appreciated that programmers will check-out one or more CPEs in many other contexts also.

Thus, described herein is a recommendation tool that informs programmers of associated and dependent CPEs as well as patterns in the development and maintenance of a source code database. The recommendation tool extracts information from code check-ins. In this way, a computer programmer is informed of any potential impact that modification to one CPE will have on another CPE within a computing system.

As described herein, for purposes of this document, a programmer is a user who checks-out (e.g. accesses) or checks-in, via a computing device, one or more CPEs in order to review, analyze, add and/or modify one or more CPEs that comprise part of a code database. Modifying programming code includes, but is not limited to adding code, deleting code, merging code or changing code.

As described herein, for purposes of this document, a CPE is illustrated and described as a source code file. However, it is appreciated, without departing from the scope thereof, that CPEs in the context of this document can also be interpreted as relating to particular development areas (Internet Explorer®, HTML rendering, Multimedia) within a computing system or software product (e.g. operating system, browser, integrated development environment, Microsoft Word® etc.), sub-areas within the computing system (e.g. operating system user interface, browser control, Input/Output, Document Rendering), code components (e.g. DirectX), code sub-components (e.g. Sound), binaries, functions/classes, and individual lines of programming code. Thus, source code files are but one exemplary CPE and it is understood, that there are numerous different CPEs for which the recommendation tool may be implemented.

By mining information in code check-ins, a recommendation tool can discover patterns, dependencies and associations between hundreds to thousands of CPEs. The recommendation tool provides a finite number of CPEs (e.g. source code files) associated with the source code file currently or about to be modified. This finite list of associated source code files can then be reviewed and modified in association with the source code file currently or about to be modified.

### Illustrative Architecture

FIG. 1 depicts an illustrative architecture 100 in which the described techniques are employed. As illustrated, architecture 100 includes a programmer (e.g. a user) 102 operating a client computing device 104 to access and modify source file Element-1.x 106 via a network 108. Client computing device 104 may comprise one of an array of computing devices capable of accessing, modifying and/or compiling computer code, such as a server computer, a client computer, a personal computer, a laptop computer, a mobile phone, a personal digital assistant (PDA), and the like. Network 108, may comprise the Internet, a Local Area Network (LAN), a Wide Area Network (WAN), a wireless network, and/or the like.

In illustrated architecture 100, user 102 may check-out Element-1.x 106 for the purpose of modifying the source code file. One or more servers 110 store Element-1.x 106. The servers 110 host at least part of a computing system made up of numerous source code files. As illustrated, the servers 110 individually, or in combination, store or otherwise have access to computer programming data 112 (e.g. via code databases such as in managed code environments) including a plurality of CPEs (1) . . . (N). Hereinafter the plurality of CPEs is referred to as source code files. Furthermore, servers 110 are capable of compiling the computer programming data 112 when the computer programming data is modified by a user 102.

While FIG. 1 illustrates a user 102 checking-out Element-1.x 106 via a network 108, it is understood that a user 102 can also check-out Element-1.x 106 directly at the location of the servers 110 storing the computer programming data 112.

As illustrated, the servers 110 include one or more processors 114 and at least one memory 116. Memory 116 stores the computer program data 112, transaction data 118, and a transaction mining tool 120.

The transaction data 118, for example includes a plurality of previous transactions 122 T₁, T₂, T₃, . . . T_{N}. In many instances transaction data 118 will store hundreds to thousands of transactions, wherein T_{N} is equal to the number of transactions stored over a period of time. However, it is contemplated that some computing environments may include far fewer or far more transactions over a period of time. Thus, the number of transactions is associated with the size and complexity of the computing environment, and how many programmers develop, update, and maintain the applications over a period of time.

For purposes of this document, a transaction may be considered equivalent to a code check-in as previously discussed. Thus, the transaction data 118 stores information associated with numerous code check-ins performed by a plurality of programmers.

As previously discussed, a code check-in could include a set of source code files that are checked-out, modified and subsequently checked-in together, or a set of new source code files developed and subsequently checked-in together thereby adding additional source code files to the computing environment. Of course, a check-in can also be a combination of modified source code files that previously existed in a computing environment and new source code files developed and thereby added to a computing environment.

Furthermore, in at least one embodiment the transaction data 118 may store time data 124, t₁, t₂, t₃ . . . t_{N}, and/or person data 126 p₁, p₂, p₃ . . . p_{N} associated with each transaction 122 T₁, T₂, T₃ . . . T_{N} respectively. The time data 124 corresponds to a timestamp indicating the date and time when a particular code check-in (or check-out) occurred. The person data 126 uses a unique identification to identify the person (e.g. programmer) who performed the code check-in. The time data 124 and the person data 126 can be used in a variety of ways, such as to help determine the strength of associations between source code files as described later in this document.

In response to the user 102 checking-out Element-1.x 106, a recommendation tool 128 provides (e.g., displays) a recommendation to the user 102. In one embodiment, the user 102 checks-out Element-1.x 106 by simply entering the name (or another form of unique identification) of the source code file (e.g. Element-1.x 106) at the computing device 104 for service to the servers 110. By entering the name of a source code file, a user is indicating that he or she intends to check-out, analyze and possibly modify the source code file.

The recommendation tool 128 indicates one or more source code files (e.g. Element-2.x, Element-3.x, Element-6.x, Element-7.x, and Element-11.x) that are associated with Element-1.x 106, which the user is currently modifying or intends to modify. As depicted, recommendation tool 128 indicates associated source code files. The recommendation tool does not indicate each source code file in an ordered set of source code files, for example. Note that Element-4.x and Element-5.x are not recommended via the recommendation tool in the illustrated example. Although the illustrated recommendation tool 128 in this example lists and ranks associated source code files according to association percentage values, it is understood that the source files can be recommended in a variety of ways.

Examples of implementations of recommendation tool 128 include a Graphical User Interface (GUI) that pops-up allowing the user 102 to be presented with the recommendation, a textual representation in a command line of a computer programming application utilized by the user 102 at the computing device 104, an audio recommendation via an audio component on the computing device 104, or a combination thereof implemented separately or as part of an integrated development environment (IDE) used to manage check-out and modification of source code files. In each implementation, the recommendation is a combination of hardware (e.g. computer monitor) and software. In at least one embodiment the combination of hardware and software is utilized to present recommendations to a user 102 who is modifying computer programming code.

Once the user 102 submits the name of a source code file (e.g. Element-1.x 106) that he or she intends to, check-out, analyze, and possibly modify, the transaction mining tool 120 gathers information from the code check-ins stored in the transaction data 118. Using the information gathered by the transaction mining tool 120, the system can determine and generalize associations and dependencies between the source code file intended to be analyzed and modified (e.g. Element-1.x 106) and other source code files in the programming data 112, and can recommend the other source code files accordingly.

Thus, the transaction mining tool 120 mines the stored transaction data 118 and provides information to be presented to the user 102. As illustrated in FIG. 1, the transaction mining tool 120 provides information to the recommendation tool 128. The recommendation tool 128 presents the user 102, via a GUI, with five source code files (Element-2.x, Element-3.x, Element-6.x, Element-7.x, and Element-11.x) that should be reviewed and/or modified in conjunction with Element-1.x 106 based on previous code check-ins performed. The percentages next to the individual source code files represent an association value between the recommended source code file and the source code file about to be modified (e.g. Element-1.x 106). This association value gives an indication of strength of association between two source code files. Thus, as illustrated the association value between Element-1.x and Element-2.x is 99.3%. The association value between Element-1.x and Element-11.x is 75.4%. Therefore, Element-2.x is recommended to the user 102 as having a stronger association to Element-1.x than Element-11.x. Further implementation in determining the association values is described later in this document.

FIG. 2 further illustrates an architecture 200 as depicted in FIG. 1. Particularly, FIG. 2 illustrates software modules that make up at least part of the transaction mining tool 120 stored on the servers 110. The servers 110 have one or more processor(s) (shown in FIG. 1) and a memory 116 including an operating system 202.

Memory 116 is but one example of computer-readable media, and in some embodiments transaction mining tool 120 may be stored on computer-readable media outside of servers 110. Computer-readable media can be any available media that can be accessed by a computing device such as computing device 104. Computer-readable media includes both volatile and nonvolatile media, removable and non-removable media. By way of example, and not limitation, computer-readable media comprises computer storage media. “Computer storage media” includes volatile and nonvolatile, removable and non-removable media implemented in any method or technology for storage of information such as computer-readable instructions, data structures, program modules, or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computing device such as computing device 104.

In various embodiments the transaction mining tool 120 is made up of one or more software modules. In at least one embodiment transaction mining tool 120 includes: a frequency tracker module 204, an itemset passing module 206, a time weighting module 208, a person weighting module 210. In some embodiments other weighting module(s) 212 may be included. These modules are utilized individually, or in combinations to determine associations between two source code files. These modules can selectively be utilized and combined to strengthen the recommendation of associated source code files presented to the user 102 via the recommendation tool 128.

FIG. 3 illustrates one example of how the transaction mining tool 120 determines associations between source code files at 300. In this example, the transaction mining tool 120 utilizes the frequency tracker module 204 to determine source code files that are historically (e.g. frequently) checked-in together. In FIG. 3, there are six previous code check-ins 302, which the frequency tracker module 204 mines to gather information and determine patterns, associations and dependencies. In the illustrated architecture in FIG. 1, these six previous code check-ins 302 are stored in the transaction data 118. For the purposes of this example, only six previous code check-ins 302 are used in order to provide simplicity in understanding. However, it is understood that in most complex computing systems, there could be exponentially more code check-ins used to gather information on source code files typically checked-in together by a plurality of programmers.

As previously discussed, when programmers intend to make a code modification or addition, they will typically check-out and modify or add a set of source code files. This modification or fix occurs in one transaction (e.g. code check-in). Associations between source code files exist because the source code files are often programmed to work together to provide proper programming and functionality within the computing system. Thus, a particular set of source code files are typically modified together (e.g. in a group). In FIG. 3, assume A, B, C, D are symbols denoting individual source code files that make up at least part of a computing system. The transaction mining tool 120 will utilize the frequency tracker module 204 to mine the previous code check-ins 302 and ascertain patterns, associations and dependencies between the source code files upon which the recommendation is presented to the user 102 via the recommendation tool 128.

As illustrated in the previous code check-ins 302 in FIG. 3, a first check-in performed by a first programmer, modified or added source code files A and B. A second check-in performed by a second programmer, modified or added source code files A and C. A third check-in performed by a third programmer modified or added source code files A, B and C. A fourth check-in performed by a fourth programmer modified or added source code files B and D. A fifth check-in performed by a fifth programmer modified or added source code files A, C and D. Finally, a sixth check-in performed by a sixth programmer modified or added source code files C and D.

While the above discussion indicates different code check-ins performed by different computer programmers, it is noted that an individual programmer is capable of performing more than one code check-in over a period of time. In fact, it is more likely an individual programmer performs numerous code check-ins relating to code maintenance and development in association with a particular computer programming code database over a period of time. Additionally, the six code check-ins 302 as illustrated in FIG. 3 are used for exemplary purposes only. It is understood that more complex computing systems would likely include many more check-ins of possibly interconnected source code files. Thus, at any given time, a programmer could check-out and modify or add any number of source code files in an individual transaction.

Next, FIG. 3 illustrates one example of how the frequency tracker module 204 determines associations between the source code files A, B, C and D based on the six code check-ins 302. In this example, the frequency tracker module 204 mines the previous code check-ins 302 and creates a matrix 304 indicating associations between source code files A, B, C and D. For example, when any of the six computer programmers who performed the previous code check-ins 302 checks-out and modifies File A (e.g. check-ins 1, 2, 3 and 5), File B is modified 50% of the time (e.g. check-ins 2 and 3). Thus, the association for A→B is 0.5. When File C is checked-out and modified (e.g. check-ins 2, 3, 5 and 6), File A is modified 75% of the time (e.g. check-ins 2, 3 and 5). Thus, the association for C→A is 0.75. Accordingly, the frequency tracker module 204 mines previous code check-ins 302 and determines associations between individual source code files, thereby creating a matrix 304 with corresponding association values.

In at least one embodiment, the associations determined in the matrix 304 correspond directly to the association values (presented as percentages) indicated via the recommendation tool 128 in FIG. 1.

Furthermore, in some embodiments the source code files recommended via the recommendation tool 128, are source code files that meet a defined threshold. In a practical example, a group administrator may set a threshold that any source code files with an association value of strength 50% or higher must be indicated via the recommendation tool 128 to any individual computer programmer in the programming group which the group administrator supervises. In another practical example, a computer programmer can set a defined threshold based on his/her own level of experience relating to the CPEs being checked-out, analyzed and/or modified.

Thus, using the numbers in the matrix 304 with a defined threshold of 50%, if a user 102 intends to modify File A, the recommendation tool 128 will indicate File B and File C as associated files with their corresponding association value strengths of 50% and 75% respectively, while not recommending File D. If another user 102 intends to modify File C, the recommendation tool 128 will indicate File A and File D as associated files with their corresponding association value strengths of 75% and 50% respectively, while not recommending File B.

Of course, the example illustrated in FIG. 3 utilizes a small set of source code files (A, B, C and D) and only six previous code check-ins 302. Thus, the numbers in the matrix 304 created by the frequency tracker module 204 include association values that are easy to understand for exemplary purposes. However, it is understood that with the possibility of hundreds to thousands of source code files, and possibly hundreds to thousands of previous code check-ins, the association values may be more granular. For example, the recommendation tool could present ten source code files with association values strengths of 99.4%, 99.2%, 98.5%, 97.2%, 95.4%, 93%, 91.1%, 89.7%, 87.5% and 85.4%. In this example, the defined threshold may be association values with at least a strength of 85%.

With more granular association values, numerous source code files may approach an association value within five percentage points of 100% while other source code files in the same computing system may approach an association value closer to 0%. Therefore, careful consideration is given when determining a defined threshold for the recommendation tool 128.

For example, an experienced programmer may have a defined threshold set at 95% because the group administrator is aware the experienced programmer has a high knowledge level of the computing environment and therefore does not need to review and check all the associated source code files that do not meet the 95% threshold. On the other hand, if a programmer has limited experience, the group administrator may set a relatively low defined threshold (e.g. 75%) for the recommendation tool 128 so the programmer with limited experience is presented with a recommendation to review a more exhaustive list of associated source code files and make sure he or she has modified all source code files necessary to avoid any potential errors.

Furthermore, in another example, the defined thresholds can be set in accordance with functionality of a particular computing environment and the severity of any potential consequences resulting from modification error(s) within the computing environment. For example, if a computing environment is programmed to control a nuclear reactor, the defined threshold should be set very low so that any user 102 making a modification checks code with a much stronger threshold (e.g. lower tolerance) compared to a computing environment programmed to control an email login system, where the tolerance for failures may be significantly higher. In this way, an error that could create a catastrophic consequence is more heavily controlled.

Ultimately, the transaction mining tool 120 utilizes the frequency tracker module 204 to extract data from the transaction data 118 and presents, via the recommendation tool 128, a finite list of associated source code files that meet a defined threshold to the user 102. In at least one embodiment this list is ranked according to the strength of the association values for each individual source code file.

In some embodiments, a user 102 may indicate, or pass the name of two source code files that he or she intends to check-out and modify together. In this scenario, the transaction mining tool 120 uses the frequency tracker module 204 to further recommend, via the recommendation tool 128, source code files based on an aggregate of the two source code files being checked-out and modified together by the user 102.

For example, FIG. 3 illustrates that Files A and B are checked-in together in check-ins 1 and 3. Thus, if a user 102 indicates that he or she intends to check-out and modify Files A and B together, the frequency tracker module 204 will mine the previous code check-ins 302 and determine File C is modified with 50% frequency (e.g. check-in 3) when Files A and B are checked-out and modified together. Thus, the association for AB→C is 0.5.

Again, it is understood that more complex computing systems could be made up of hundreds to thousands of interconnected source code files and corresponding numbers of previous code check-ins. Thus, in most scenarios the association values determined for an aggregate of source code files will also be more granular when recommending a finite list of associated source code files.

### Illustrative Processes

Exemplary operations are described herein with reference to FIGS. 4-5. The processes are illustrated as logical flow graphs, which represent a sequence of operations that can be implemented in hardware, software, or a combination thereof. In the context of software, the operations represent computer-executable instructions that, when executed by one or more processors, perform the recited operations. Generally, computer-executable instructions include routines, programs, objects, components, data structures, and the like that perform particular functions or implement particular abstract data types. The order in which the operations are described is not intended to be construed as a limitation, and any number of the described operations can be combined in any order and/or in parallel to implement the process.

FIG. 4 depicts an illustrative process 400 for mining code check-ins and recommending associated source code files (or other CPEs) to a user 102.

At 402, the transactions mining tool 120 monitors transactions on the servers 110. The transactions are performed by multiple programmers over a period of time. In at least one embodiment the period of time may be defined to be the life of the development and maintenance of a particular application (e.g. the SDLC for the application). In some embodiments the period of time may be a user-defined time period in which a particular development or maintenance task is occurring. In at least one embodiment periods of time may be defined as the SDLC in some instances, such as critical infrastructure applications, and user-defined in others, such as for particular testing projects.

At 404, information associated with each transaction monitored in 402 is stored in the transaction data 118. In some embodiments, the respective time data 124 and person data 126 are stored in associations with the transaction(s) as discussed in the exemplary architecture of FIG. 1.

At 406, the transaction mining tool 120 utilizes the frequency tracker module 204 to determine associations between CPEs (e.g. source code files) based on source code files that are historically checked-in together. FIG. 3 discusses one implementation where the frequency tracker module 204 determines these associations.

At 408, the servers 110 receive an indication that a CPE is being checked-out. In at least one implementation, the user 102 submits the name of the source code file he or she intends to check-out, analyze and possibly modify.

At 410, based on mined patterns, dependencies, and/or associations for the CPE being checked-out, the recommendation is provided via the recommendation tool 128. As previously discussed, the recommendation tool 128 can be in the form of GUI that presents a finite ranked list of source code files and association values (e.g. percentages) that meet a defined threshold. Therefore, the user 102 is informed of associated source code files that programmers have previously checked-out and modified or added in shared transactions with the source code file the user 102 intends to check-out.

### Weighted Association Values

While FIG. 3 discusses one embodiment of determining association values, it is understood that association values can be determined using other embodiments also. These other embodiments in addition to independently determining association values, also provide techniques that weight the association values, thereby adjusting a previously determined association value to further indicate a degree of confidence in the strength of association. The transaction mining tool 120 uses these weighting techniques to indicate via the recommendation tool 128, the relative strength of an association between two or more source code files. For the purposes of this document, as described herein, association values adjusted (e.g. weighted) by particular weighting techniques are referred to as weighted association values because the weighting techniques indicate a degree of confidence in the associations determined by the transaction mining tool 120. The degree of confidence can also be referred to as a statistical confidence level because it indicates the strength of association between at least two source code files. Weighted association values, similar to the association values previously discussed, are presented via the recommendation tool 128 along with their corresponding source code files. In some embodiments such a recommendation is presented in the form of a finite ranked list of source code files indicated with percentages.

FIG. 5 depicts an exemplary process 500 illustrating an embodiment of determining associations between source code files using a weighting technique. In FIG. 5, the transaction mining tool 120 utilizes the itemset passing module 206 to weight the associations between source code files. In some embodiments, the weighting technique in FIG. 5 can be solely applied to set of code check-ins (e.g. the six code check-ins 302 in FIG. 3) in order to initially determine association values. In other embodiments, the weighting technique in FIG. 5 can build on the association values created by the frequency tracker module 204 in the matrix 304 in FIG. 3. In this scenario, the frequency tracker module 204 and the itemset passing module work 206 together to not only determine association values, but to further weight the association values thereby producing weighted association values indicating a degree of confidence. In at least one embodiment, at 502, the transaction mining tool 120 utilizes the itemset passing module 206 to discover itemsets of size 1. An N-itemset is defined as a transaction in which a computer programmer checks-out and modifies or adds N source code files. For example, as illustrated in FIG. 3, size 1 itemsets include previous check-ins 302 in which the computer programmer checks-in two source code files. Thus, code check-ins 1, 2, 4 and 6 in FIG. 3 are size 1 itemsets since only two source code files were checked-out and modified or added in the code check-ins. This round of discovery relating to itemsets of size 1 is referred to as a first pass by the itemset passing module 206.

At 504, the itemset passing module 206 discovers itemsets of size 2 in a second pass. Size 2 itemsets include previous code check-ins 302 in which the computer programmer checked-in three source code files (e.g. one more source code files than size 1 itemsets). Thus, check-ins 3 and 5 in FIG. 3 are size 2 itemsets since three source code files were modified in the check-ins.

At 506, itemset passing module 206 iteratively discovers itemsets of size M, where M represents further passes up to size M. Accordingly, in at least one embodiment, M may be equal to the code check-in 302 with the largest N-itemset such that the itemset passing module 206 discovers and mines all transactions stored in the transaction data 118. In some embodiments M may be defined so that less than all transactions stored in the transaction data 118 are mined. As illustrated in FIG. 3, the largest itemset of the previous code check-ins 302 is of size 2. However, it is to be appreciated in the context of complex computing systems that there may be code check-ins 302 with much larger itemsets.

In some embodiments, M may define a cut-off set by an administrator of the computing system. For example, the administrator can define a cut-off M so that the transaction mining tool 120 and the itemset passing module 206 stop after completing ten passes of size 1, 2, 3, 4, 5, 6, 7, 8, 9 and 10. In this scenario, a code check-in 302 with an itemset of more than eleven source code files will not be used by the itemset passing module 206 to determine associations. In this scenario, the administrator may conclude that mining a transaction with an itemset of more than eleven source code files would not result in strong indications of associations, patterns and dependencies. Therefore, there is no reason to expend the processing time and resources associated with the transaction mining tool 120 to mine such large itemsets. In an alternate scenario, a code check-in 302 with an itemset of a small number of source code files will not be used by the transaction mining tool 120 to determine associations, (e.g. passes of size 1 or 2). In this scenario, the administrator may conclude that mining a transaction with an itemset of so few source code files would not provide enough data to indicate associations, patterns and dependencies. In yet another scenario, code check-ins of itemsets above and below defined thresholds may be excluded from mining for reasons similar to those discussed above.

At 508, association values are initially determined and/or weighted according to the number of passes completed by the itemset passing module 206. When weighting the associations, the itemset passing module 206 uses previous code check-ins of different sizes. Thus a relative association can be determined, and ultimately recommended, based on itemsets of size 1 . . . M.

In at least one embodiment, for example, an itemset of size 1 (e.g. two source code files checked-in together) may indicate a stronger association than an item set of size 5 (e.g. six source code files checked-in together). The itemset of size 1 may indicate a stronger association because it is known that a computer programmer modified or added File B, for example, when initially checking-out and modifying File A. Thus, there is a 1:1 correspondence. On the other hand, an itemset of size 5 may not indicate as strong of an association as an itemset of size 1 because an itemset of size 5 indicates six source code files checked-out and modified or added together. Thus, there is no 1:1 correspondence in an itemset of size 5. Thus, the dependencies may not be as clearly defined. For example, a code check-in with an itemset of size 5 includes Files A, B, C, D, E and F checked in together. If a programmer initially intended to modify File A, it may be unclear which files depend upon File A. Any one or more of files B, C, D, E and/or F alone or in combination could depend upon File A. Furthermore, the dependencies may not be direct. For example, File B may have been modified or added because of a dependency upon File C, which was modified in response to File A being modified. Thus, the associations between source code files determined by the transaction mining tool 120 may not be as strong when the itemset size increases. Accordingly, check-ins with smaller sizes of itemsets may be weighted more than check-ins with larger sizes of itemsets.

Thus, in some embodiments the association values previously discussed in FIG. 3 can be weighted by the itemset passing module 206 and recommended via the recommendation tool 128. Weighting the association values, for example, based on the size of the itemset, can adjust the association values accordingly and indicate a degree of confidence to be presented to the user 102.

In some embodiments, association values can be adjusted based on the size of the itemset by using one or more algorithms to determine weighting coefficients to be applied to the association values. For example, weighting coefficients (1, 0.9, 0.8, 0.7, etc.) can be applied to the association values based on whether the transaction was discovered in the first pass, second pass, etc. Additionally, regression or other evolutionary algorithms can be used to determine weighting coefficients.

Additionally, FIG. 6 illustrates how the transaction mining tool 120 utilizes the time weighting module 208 and the person weighting module 210 to determine and/or adjust association values according to time data 124 and person data 126, although either may be implemented independently. As illustrated in FIG. 6, each individual previous code check-in 602 includes timestamp (e.g. t₁, t₂, t₃, t₄, t₅, t₆) indicating a date and time when the check-in (or check-out) occurred and a person identification (e.g. p₁, p₂, p₃, p₄, p₅, p₆) uniquely identifying the programmer performing the check-in (or check-out). The time data 124 stores the timestamp applied to every transaction when a programmer checks-in a plurality of source code files.

The time data 124 allows the time weighting module 208 to apply relative associations between individual source code files, based on the time when the check-in occurred.

For example, if a programmer checked-in Files A and B as illustrated in FIG. 6 code check-in 1, and then ten minutes later the same (or different) programmer checked-in Files A and C (code check-in 2 in FIG. 6), then the time data 124 can be used to indicate a strength of association based on the time difference, t₁, −t₂=delta t, of the two transactions.

In one some embodiments, the time weighting module 208 weights association values according to delta t, thereby adjusting (e.g. strengthening) the association values to indicate a degree of confidence incorporating a delta t.

In some embodiments, the time weighting module 208 determines that code check-in 1 and code check-in 2 should be treated as a single transaction based on delta t, thereby combining the two transactions so that Files A, B and C are associated in one transaction.

This example can be illustrated in a practical scenario where the programmer forgets to change necessary programming code in File C (FIG. 6 check-in #2) that relates to the modifications he previously made in Files A and B (FIG. 6 check-in #1). Thus, although File C was modified with File A in a separate transaction, the time weighting module 208 uses the timestamp to combine the transactions into one transaction.

It is understood that this weighting technique supports the assumption that the closer in time two separate check-ins occur, the more likely it is that the two separate check-ins are related, and therefore association values should be determined and/or adjusted to indicate a degree of confidence associated with a delta t. The ten minute difference previously discussed in relation to code check-in 1 and code check-in 2 is used for exemplary purposes only. Thus, any time period or time difference may be defined to weight the association between individual source code files or combine two transactions into one transaction. Furthermore, the time data 124 can be used to strengthen the associations based on a definite time threshold (e.g. 10 minutes, 12 hours, 1 day, 1 week, etc.). In at least one embodiment, a definite time threshold may not be implemented and strength associations and weighting factors are determined linearly based on a difference (delta t) in time between two individual code check-ins.

Furthermore, using the person data 126, the person weighting module 210 can determine relative associations between individual source code files based on distance metrics (delta p) between two programmers (e.g. persons) performing two previous code check-ins 602. In order to determine the delta p the person weighting module 210 may access a structure of an organization or a social network.

In one embodiment, an organization hierarchy tree is employed with a plurality of nodes representing different persons within the organization. In this example, each node in the organizational hierarchy tree has a manager or parent node, up to the most senior or root node. Using the organization hierarchy tree, the person weighting module 210 determines the distance, delta p, in number of nodes, between two programmers performing two code check-ins. In one embodiment the person weighting module 210 may count the least number of nodes between the two programmers through a common manager in the organization hierarchy tree.

For example, assume the hierarchy tree 604 illustrated in FIG. 6 is a section of a larger organizational hierarchy tree corresponding to employees in a corporation. Within the hierarchy tree 604 there is a senior manager 606, a team 1 manager 608, a team 2 manager 610, two team 1 programmers 612 and 614, and two team 2 programmers 616 and 618. Each node corresponds to a person within the organization.

In the first scenario, team 1 programmer 612 and team 1 programmer 614, under the same team 1 manager 608, perform two separate code check-ins. Thus, the programmer (persons) distance metrics corresponding to these two separate code check-ins is two based at least in part on the person weighting module 210 counting nodes to the most common managing node. In this scenario, team 1 programmer 612 and team 1 programmer 614 have common team 1 manager 608 and thus traversing the hierarchy tree from team 1 programmer 612 to team 1 programmer 614 via common team 1 manager 608, the person weighting module 210 will count two nodes. Here the distance metrics, delta p, is equal to two.

In a second scenario, team 1 programmer 612 and team 2 programmer 618 perform two code check-ins. In the second scenario, the programmer (persons) distance metrics corresponding to the two separate code check-ins is four based at least in part on the closest common managing node being the senior manager 606. Thus, traversing the hierarchy tree from team 1 programmer 612 to team 2 programmer 618 via senior manager 606, the person weighting module 210 will count four nodes. Here the distance metrics, delta p, is equal to four.

Using the first and second scenarios described above, the transaction mining tool 120 weights associations values based on the determined distance metrics delta p. The lower the distance metric delta p is, the stronger the associations between source code files modified in two separate check-ins is weighted because, for example, members of the same programming team are more likely to be modifying and adding source code files that should be checked-in together within a particular computing environment. Thus, the first scenario explained would determine a stronger association than the second scenario, and the association values would be weighted accordingly into values indicating a degree of confidence.

It is understood the discussed weighting techniques can be implemented separately or in combination with other weighting techniques. For example the itemset sizes discussed in FIG. 5 could be combined with the time data 124 and the person data 126 to produce values that indicate a degree of confidence corresponding to associated source code files. The discussed techniques ultimately work individually, or in combination, to indicate to a user 102 checking-out and modifying a CPE, a probability that another CPE should be modified in conjunction with the checked-out CPE.

Furthermore, in some embodiments, in addition to recommending source code files as explained, other implementations recommending additional information can also be realized. For example, the transaction mining tool 120 may mine data associated with ownership of a particular source code file. In this example, a user 102 changing source code files Element-1.x 106 will be informed of an identification of an owner (e.g. original programmer, programmer who last modified the source code file, administrator) of Element-1.x. Thus, if any questions or issues arise, user 102 could contact the owner in order to find out more information about Element-1.x 106. In another embodiment, the user 102 would need to obtain authorization from the owner to modify Element-1.x 106.

In some embodiments, a further recommendation can be given to the user 102 about a depth of inheritance of the source code file to be modified. The user 102, when modifying Element-1.x 106 is informed of another element of risk, for example, if Element-1.x 106 is inherited by numerous other source code files. In this sense, Element-1.x 106 may be well nested within cascading source code, and any modification to Element-1.x 106 would affect the source code files which inherit it. With this recommendation a domino effect of failures can be avoided.

In some embodiments, a recommendation can be given to the user 102 based on cyclomatic complexity of the CPE to be modified. In this implementation, the transaction mining tool 120 determines risk associated with how complex, or how important, the CPE is.

### Conclusion

Although the subject matter has been described in language specific to structural features and/or methodological acts, it is to be understood that the system and method defined in the appended claims is not necessarily limited to the specific features or acts described. Rather, the specific features and acts are disclosed as exemplary forms of implementing the claims.

1. A computer implemented method comprising:
monitoring, via a computer, a plurality of transactions comprising modifications of one or more source code files stored in a database;
storing, on a computer-readable medium, information corresponding to the plurality of transactions;
determining associations between source code files based at least in part on the information corresponding to the plurality of transactions;
receiving an indication that a particular source code file having at least one associated source code file is being checked-out of the database; and
responsive to the receiving of the indication, recommending check-out of one or more source code files that have been determined to be associated with the particular source code file.

2. The method as recited in claim 1, wherein the determining of the associations comprises assigning association values between source code files, and wherein the association values are assigned based at least in part on one or more of:
time between two separate transactions; and
metrics corresponding to a person responsible for a transaction.

3. The method as recited in claim 1, further comprising executing a modification to the particular source code file based at least in part on the providing of the recommendation.

4. The method as recited in claim 1, further comprising executing a modification to a source code file of the one or more associated source codes files based on the providing of the recommendation.

5. The method as recited in claim 1, wherein one of the plurality of transactions is a combination of two previously separate transactions occurring within a defined time interval.

6. The method as recited in claim 1, further comprising:
mining the plurality of transactions using a plurality of passes; and
weighting an association value corresponding to an associated source code file according to at least one of the plurality of passes.

7. The method as recited in claim 1, wherein the recommendation is for presentation via a user interface on a client device.

8. A computer-readable media having embodied thereon computer executable instructions, the computer-executable instructions upon execution configuring a computer to perform the method of claim 1.

9. One or more computer-readable storage media having computer-executable instructions embodied thereon, the computer-executable instructions configuring one or more processors on a computing system to perform acts comprising:
monitoring a plurality of transactions, wherein transactions comprise modifications of one or more programming elements;
responsive to the monitoring, determining associations between a plurality of programming elements;
receiving an indication that a particular programming element having at least one associated programming element is being checked-out; and
responsive to the receiving of the indication, serving a recommendation with the particular programming element being checked-out, wherein the recommendation indicates associated programming elements.

10. One or more computer-readable storage media as recited in claim 9, wherein the programming elements comprise source code files.

11. One or more computer-readable storage media as recited in claim 9, further configuring the one or more processors to perform an act comprising recommending the associated programming elements in a finite list, wherein the finite list is ranked according to association values.

12. One or more computer-readable storage media as recited in claim 11, wherein the finite ranked list is for presentation to a user via a graphical user interface.

13. One or more computer-readable storage media as recited in claim 11, wherein the finite ranked list includes a pre-defined association value threshold.

14. One or more computer-readable storage media as recited in claim 11, further configuring the one or more processors to perform acts comprising:
mining the transactions, wherein mining the transactions comprises discovering a plurality of itemsets in a pass; and
weighting the association values according to the pass.

15. A computing system including one or more computers, comprising:
a memory;
one or more processors coupled to the memory;
one or more databases storing programming code, wherein the programming code comprises a plurality of programming elements;
a transaction mining tool to determine associations between a plurality of programming elements; and
one or more databases storing transaction data indicating programming elements that have been checked-in or checked-out with one another in at least one transaction.

16. The system as recited in claim 15, wherein the associations are weighted according to an elapsed time between two transactions, thereby indicating a level of confidence in the determined associations.

17. The system as recited in claim 15, wherein the associations are weighted according to metrics corresponding to the identities of at least two persons implementing two transactions, wherein the metrics are based at least in part on positions of the two persons within an organization hierarchy.

18. The system as recited in claim 15, wherein the transaction mining tool generates a recommendation as part of an integrated design environment (IDE).

19. The system as recited in claim 18, wherein modification of one or more programming elements is facilitated in response to the recommendation.

20. The system as recited in claim 15, wherein the associations are adjusted to produce association values indicating a probability that a second programming element should be modified in response to modifying a first programming element.
